SEQUENCE LISTING (26 sequences)

SEQ ID NO: 1 - DNA, 405 bp, Aspergillus nidulans
  CDS (1)..(405): basf-dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  basf-dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): basf-rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  basf-rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): basf-hypA from chemically synthesized polynucleotide
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  basf-hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): basf-hypB from chemically synthesized polynucleotide
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  basf-hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): basf-sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  basf-sc3 hydrophobin, cDNA template
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): basf-BASF1 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  basf-BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): basf-BASF2 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  basf-BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): basf-yaad: yaad
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  basf-yaad: yaad
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): basf-yaae: yaae with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  basf-yaae: yaae with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): basf-yaad-Xa-dewA-his: fusion of Bacillus subtilis yaad and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  basf-yaad-Xa-dewA-his: fusion of Bacillus subtilis yaad and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): basf-yaad-Xa-rodA-his: fusion of Bacillus subtilis yaad and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  basf-yaad-Xa-rodA-his: fusion of Bacillus subtilis yaad and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): basf-yaad-Xa-BASF1-his: fusion of Bacillus subtilis yaad and N-terminal factor Xa proteinase cleavage site and artificial hydrophobin; BASF1  BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  basf-yaad-Xa-BASF1-his: fusion of Bacillus subtilis yaad and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 561 bp, Artificial sequence
  CDS (1)..(561): DNA sequence encoding fusion protein yaad40-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 26 - protein, 187 aa, artificial sequence
  fusion protein yaad40-Xa-dewA-his
MAQTGTERVKRGMAEMQKGGVIMDVINAEQAKIAEEAGAVIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

(19) United States
(12) Patent Application Publication
(10) Pub. No.: US 2012/0006354 A1
(43) Pub. Date: Jan. 12, 2012

(54) COMPOSITION AND METHOD FOR CLEANING SURFACES

(75) Inventors: Ulf Baus, Dossenheim (DE); Thorsten Montag, Dudenhofen (DE); Claus Bollschweiler, Heidelberg (DE); Thomas Subkowski, Ladenburg (DE); Monika Haas, Frankfurt (DE); Ralf Haak, Worrstadt (DE)

(73) Assignee: BASF SE, Ludwigshafen (DE)

(21) Appl. No.: 13/177,598

(22) Filed: Jul. 7, 2011

Related U.S. Application Data
(60) Provisional application No. 61/361,947, filed on Jul. 7, 2010.

(30) Foreign Application Priority Data
Jul. 7, 2010 (EP) 10168712.7

(51) Int. Cl. B08B 3/08; C11D 3/60

(52) U.S. Cl. 134/6; 510/214; 510/477; 510/488

(57) ABSTRACT

The present invention relates to a method for cleaning surfaces using an aqueous composition comprising at least one hydrophobin and a synergistically effective, non-interface-active, water-soluble additive. The method is suitable in particular for cleaning hard, hydrophobic, poorly wettable surfaces, such as, e.g., plastic floors.

### RELATED APPLICATIONS

This application claims benefit of U.S. provisional patent application Ser. No. 61/361,947, filed Jul. 7, 2010, which is incorporated by reference in its entirety. This patent application claims benefit of European patent application Serial Number EP 10168712.7, filed Jul. 7, 2010, which is incorporated by reference in its entirety.

### SUBMISSION OF SEQUENCE LISTING

The sequence listing associated with this application is filed in electronic format via EFS-Web and is hereby incorporated by reference into the specification in its entirety. The name of the text file containing the Sequence Listing is SEQUENCE_LIST_{—}13156-00417-US_ST25.txt. The size of the text file is 73 KB, and the text file was created on Jul. 6, 2011.

### BACKGROUND OF THE INVENTION

The present invention relates to a method for the cleaning or pretreatment of surfaces using a cleaner formulation. It also relates to the cleaner formulation comprising at least one hydrophobin and at least one synergistically effective non-interface-active, water-soluble additive, which dissociates into ions especially in aqueous solution. This increases in particular the hydrophilicity and wettability of the surface for polar solvents, such as water. The method is suitable in particular for cleaning hydrophobic, poorly wettable surfaces, e.g. hard surfaces, such as plastic floors. Furthermore, the invention relates to a chemical composition for cleaning surfaces, comprising at least one hydrophobin and an especially synergistically effective non-interface-active, water-soluble additive that preferably dissociates into ions in aqueous solution.

### DESCRIPTION OF RELATED ART

Hydrophobins are particularly small, cysteine-rich proteins of about 100 to 150 amino acids, which occur, e.g., in filamentous fungi such as Schizophyllum commune. They generally have 8 cysteine units in the molecule. Hydrophobins can be isolated from natural sources, but they can also be obtained by means of genetic engineering methods, as disclosed, for example, in WO 2006/082 251 or WO 2006/131 564. The prior art describes, inter alia, the surface-active and emulsifying effects of hydrophobins, and also various applications for hydrophobins. WO 1996/41882 proposes the use of hydrophobins as emulsifiers, thickeners, surface-active substances, for the hydrophilization of hydrophobic surfaces, for improving the water resistance of hydrophilic substrates, for producing oil-in-water emulsions or water-in-oil emulsions. Furthermore, pharmaceutical applications are proposed, such as producing ointments or creams, and also cosmetic applications such as skin protection or producing hair shampoos or hair rinses.

WO 2006/082253 discloses formulations for coating surfaces, e.g., finely-divided inorganic or organic particles, with hydrophobins. For this, the aqueous hydrophobin solutions are applied to the surface to be coated.

Cleaning compositions and care compositions for hard and elastic surfaces are known to the person skilled in the art and generally comprise a mixture of different surfactants, and optionally further washing-active additives such as enzymes, acids, bases, bleaching and scouring agents, which intensify the cleaning, i.e. soiling (such as fat, oil lime) removing effect. The solvent used in cleaning compositions is predominantly water, which itself significantly contributes to the cleaning effect on account of its polar properties.

Cleaner compositions often consist of mixtures of different surfactants which increase the detachment of hydrophobic parts of soiling (e.g. grease, oil) in the aqueous cleaning composition. Surfactants, which are also referred to below as surface-active or interface-active substances, are characterized in that they reduce the surface tension of a liquid (e.g. water) in which they are dissolved. The large number of anionic, cationic, nonionic and amphoteric surfactants is known to the person skilled in the art for a very wide variety of applications.

Besides good cleaning performance, the toxicological safety and, with regard to low waste-water contamination, the biodegradability are of particular importance for a cleaning composition.

Furthermore, for the cleaning effect and a so-called “easy-to-clean-effect”, the simple and uniform wetting of the surface to be cleaned by the cleaning composition and/or care composition is of decisive importance. For ecological and application-related reasons, the cleaning and/or care compositions used are usually aqueous compositions. However, these in particular naturally exhibit an inadequate wetting behavior on hydrophobic surfaces. The wetting behavior can be improved by means of surfactants. However, surfactants have disadvantages in relation to the longevity of the effect and the tendency towards re-soiling. Moreover, customary surfactants can lead to waste-water contamination.

It is known to provide hard surfaces such as, for example, glass, ceramic or floors, with soil-repelling coatings or a coating for increasing or reducing the hydrophilicity. These finishes can prevent soil adhesion and facilitate subsequent cleaning. These may be permanent coatings, or else a temporary protection. A temporary soil-repelling effect can be achieved, for example, by substances in a cleaner formulation which are applied to the surface during cleaning. Important fields of application of such cleaners are domestic applications, such as cleaners for the kitchen sector, living sector or sanitary sector, but also industrial applications, such as for example, cleaners for car washing. EP-A 0 467 472 discloses a composition for increasing the hydrophilicity of hard surfaces, for example surfaces in the home, in order to achieve easier cleaning in subsequent cleaning steps. The formulation comprises a water-soluble, ionic or nonionic polymer, for example a cationic polymer with quaternized ammonium alkyl methacrylate units.

Document WO 2006/103215 discloses the use of hydrophobins for the soil-repelling treatment of hard surfaces, such as, for example, the surface of tiles, floors, fittings, washbasins, shower trays, bathtubs, toilets, shower cubicles, bathroom furniture, furniture, mirrors, crockery, cutlery, glassware or porcelain objects.

WO 2006/103230 discloses the use of aqueous formulations of hydrophobins for treating the surfaces of hardened mineral building materials, natural stone, artificial stone and ceramics, where a soil-repelling, hydrophobicizing or preserving effect can be achieved.

### BRIEF SUMMARY OF THE INVENTION

There is a need for environmentally friendly, virtually completely biodegradable cleaners with good wetting properties for hydrophobic surfaces which make do without or with a very small amount of conventional surfactants and, moreover, optimally utilize the cleaning effect of the water. An object of the present invention is to provide an environmentally friendly, efficient and easy-to-carry out method and also a cleaner formulation for the cleaning of in particular hydrophobic surfaces, where no further surfactants or only a very small amount of conventional surfactants are used.

Surprisingly, it has been found that particularly hard or elastic, hydrophobic and/or poorly wettable surfaces can be cleaned using an aqueous composition (cleaner formulations) which comprises hydrophobins in combination with water-soluble, non-interface-active, additives, with very good results. Moreover, hard, poorly wettable surfaces can be pretreated with the aforementioned aqueous compositions, which make subsequent cleaning easier.

As a result of the combination of at least one hydrophobin and a non-interface-active, water-soluble additive (which dissociates into ions in aqueous solution), the wetting effect of the cleaner formulation is increased significantly (in particular also synergistically). In the case of hydrophobic substrates, the composition according to the invention permits better wetting and therefore better cleaning of the surface. Upon further cleaning, the soil can be better removed, and/or the amount of surfactant required for cleaning can be significantly reduced.

In the method according to the invention using hydrophobin-containing aqueous compositions, a significantly higher permanence of the wetting effect has been found compared with purely surfactant-based systems.

It is a further advantage that the hydrophilizing effect which is achieved by the method according to the invention can be removed again by strongly alkaline or acidic solutions, in contrast to known hydrophilizing agents.

### DETAILED DESCRIPTION OF THE INVENTION

The present invention relates to a method for cleaning hydrophobic, in particular hard, hydrophobic surfaces, comprising the steps:
a) wetting of the surface with an aqueous composition,
b) absorption of the soilings by suitable means,
where the aqueous composition used comprises at least the following components:
   (i) at least one solvent (S), where the solvent often comprises at least 90% by weight, preferably 95%, particularly preferably 98%, water,
   (ii) at least one hydrophobin (H),
   (iii) at least one non-interface-active, water-soluble additive (A),
   (iv) and optionally a surfactant (T).

The weight ratio of additive (A) to hydrophobin component (H) is preferably from 2:1 to 100:1, often also from 5:1 to 100:1.

The wetting of the surface can take place for example by uniformly applying the composition to the surface. The absorption of the soilings can then take place, for example by soaking up or absorption (e.g. by cloths or absorbent materials).

Within the context of the present invention the term “hydrophobins” (H) is intended to be understood below as meaning polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

where each X independently is one or more of any of the 20 naturally occurring amino acids (Phe, Leu, Ser, Tyr, Cys, Trp, Pro, His, Gln, Arg, Ile Met, Thr, Asn, Lys, Val, Ala, Asp, Glu, Gly), and where each amino acid comprising each X can be identical or different.

Here, the subscripts adjacent each X represent the number of amino acids in the designated amino acid sequence X; C is cysteine, alanine, serine, glycine, methionine or threonine, where at least four of the radicals designated C are cysteine; and the indices n and m independently are natural numbers between 0 and 500, preferably between 15 and 300.

Each X independently denotes an amino acid sequence consisting of any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). Typically, the numerical subscripts adjacent each X indicate the number of amino acid residues comprising each X, and each amino acid residue within each X independently may be identical or different to an adjacent residue. Typically, C is cysteine, alanine, serine, glycine, methionine or threonine, wherein at least four of the radicals designated C are cysteine, and the indices n and m, independently, are natural numbers between 0 and 500, preferably between 15 and 300, indicating the number of amino acid residues comprising the adjacent X.

The polypeptides according to the formula (I) are further characterized by the property that, at room temperature after coating a glass surface, they bring about an increase in the contact angle of a water drop of at least 20°, preferably at least 25° and particularly preferably 30°, in each case compared with the contact angle of a water drop of identical size with the uncoated glass surface.

The amino acids designated C¹ to C⁸ are preferably cysteines. However, they may also be replaced by other amino acids of similar spatial filling, preferably by alanine, serine, threonine, methionine or glycine. However, at least four, preferably at least 5, particularly preferably at least 6 and in particular at least 7 of the positions C¹ to C⁸ should consist of cysteines. Cysteines can either be present in reduced form in the proteins according to the invention, or form disulfide bridges with one another. Particular preference is given to the intramolecular formation of C—C bridges, in particular those with at least one, preferably 2, particularly preferably 3 and very particularly preferably 4 intramolecular disulfide bridges. In the case of the above-described exchange of cysteines for amino acids of similar spatial filling, those C positions which can form intramolecular disulfide bridges with one another are advantageously exchanged in pairs. If, in the positions referred to as X, cysteines, serines, alanines, glycines, methionines or threonines are also used, the numbering of the individual C positions in the general formulae can change accordingly.

Preference is given to using hydrophobins of the general formula (II)

Xₙ—C¹—X₃₋₂₅—C²—X₀₋₂—C³—X₅₋₅₀—C⁴—X₂₋₃₅—C⁵—X₂₋₁₅—C⁶—X₀₋₂—C⁷—X₃₋₃₅—C⁸—Xₘ (II)

for carrying out the present invention, where X, C and the indices alongside X and C have the meaning as in formula (I), above, the indices n and m are numbers between 0 and 350, preferably 15 to 300, the proteins are furthermore characterized by the aforementioned contact angle change, and in addition at least 6 of the radicals designated C are cysteine. Particularly preferably all of the radicals C are cysteine. Preference is also give to hydrophobins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices alongside X have the meaning as in formula (I) above, the indices n and m are numbers between 0 and 200, the proteins are furthermore characterized by the aforementioned contact angle change, and at least 6 of the radicals designated C are cysteine. Particularly preferably all of the radicals C are cysteine. The radicals Xₙ and Xₘ may be peptide sequences which are naturally also linked to a hydrophobin. However, one or both radicals may also be peptide sequences which are naturally not linked to a hydrophobin. These are also to be understood as meaning those radicals Xₙ and/or Xₘ in which a peptide sequence occurring naturally in a hydrophobin is extended by a peptide sequence not naturally occurring in a hydrophobin.

If Xₙ and/or Xₘ are peptide sequences which are naturally not linked to hydrophobins, such sequences are generally at least 20, preferably at least 35, amino acids in length. These may be, for example, sequences of 20 to 500, preferably 30 to 400 and particularly preferably 35 to 100 amino acids. Such a radical naturally not linked to a hydrophobin will also be referred to below as fusion partners. This is intended to express that the proteins can consist of at least one hydrophobin part and one fusion partner part which do not occur together in nature in this form. Fusion hydrophobins comprising fusion partner and hydrophobin part are described, for example in WO 2006/082251, WO 2006/082253 and WO 2006/131564.

The fusion partner part can be selected from a large number of proteins. It is possible for just a single fusion partner to be linked with the hydrophobin part, or else for a plurality of fusion partners to be linked with a hydrophobin part, for example, on the amino terminus (Xₙ) and on the carboxyl terminus (Xₘ) of the hydrophobin part. However, it is also possible, for example for two fusion partners to be linked with one position (Xₙ or Xₘ) of the protein according to the invention.

Particularly suitable fusion partners are proteins which occur naturally in microorganisms, in particular in Escherischia coli or Bacillus subtilis. Examples of such fusion partners are the sequences yaad (SEQ ID NO: 16 herein and in WO 2006/082251), yaae (SEQ ID NO:18 herein and in WO 2006/082251), ubiquitin and thioredoxin. Of high suitability are also fragments or derivates of these specified sequences, which comprise only part, for example 70 to 99%, preferably 5 to 50%, and particularly preferably 10 to 40%, of the specified sequences, or in which individual amino acids, or nucleotides are changed compared with the specified sequence, the percentage data referring in each case to the number of amino acids.

The assignment of the sequence names to DNA and polypeptide sequence and the corresponding sequence protocols can be found at the end of the present description and in the application WO 2006/103225 (page 13 of the description and sequence protocol).

In a further preferred embodiment, the fusion hydrophobin has, besides the specified fusion partner, as one of the groups Xₙ or Xₙ, or as terminal constituent of such a group, also a so-called affinity domain (affinity tag/affinity tail). Here, these are, in a manner known in principle, anchor groups which can interact with certain complementary groups and can serve for easier work-up and purification of the proteins. Examples of such affinity domains comprise (His)ₖ, (Arg)ₖ, (Asp)ₖ, (Phe)ₖ or (Cys)ₖ groups, where k is in general a natural number from 1 to 10. Preferably, it may be a (His)ₖ group, where k is 4 to 6. Here, the group Xₙ and/or Xₘ can consist exclusively of such affinity domains or else a radical Xₙ or Xₘ linked naturally or not naturally with a hydrophobin is extended by a terminally arranged affinity domain. The hydrophobins used according to the invention can also be further modified in their polypeptide sequence, for example by glycosilation, acetylation or else by chemical crosslinking, for example with glutardialdehyde.

One property of the hydrophobins or derivatives thereof used according to the invention is the change in surface properties when the surfaces are coated with the proteins. The change in the surface properties can be determined experimentally, for example, by measuring the contact angle of a water drop before and after coating the surface with the specific protein and ascertaining the difference between the two measurements. The contact angle measurement procedure is known in principle to the person skilled in the art. The measurements relate to room temperature and water drops of 5 μl and using glass platelets as substrate. The precise experimental conditions for an example of a suitable method for measuring the contact angle are given in the experimental section. Under the conditions specified therein, the fusion proteins used according to the invention have the property of enlarging the contact angle by at least 20°, preferably at least 25°, particularly preferably at least 30°, in each case compared with the contact angle of a water drop of identical size with the uncoated glass surface.

Particularly preferred hydrophobins for carrying out the present invention are the hydrophobins of the type dewA, rodA, hypA, hypB, sc3, basf1, basf2 (SEQ ID No:1 to SEQ ID No: 14). These hydrophobins including their sequences, also are disclosed, for example in WO 2006/082 251. Unless stated otherwise, the sequences stated below refer to the sequences disclosed in WO 2006/082 251, as duplicated herein. An overview table with the SEQ. ID numbers can be found in WO 2006/082 251 on page 20 and at the end of the present description. Of particular suitability according to the invention are the fusion proteins yaad-Xa-dewA-his (SEQ ID NO: 20), yaad-Xa-rodA-his (SEQ ID NO: 22) or yaad-Xa-basf1-his (SEQ ID NO: 24) with the polypeptide sequences stated in brackets, and also the nucleic acid sequences coding therefor (SEQ ID NO 19, SEQ ID NO 21, SEQ ID NO 23), in particular the sequences according to SEQ ID NO: 19, 21, 23. Within the context of the present invention, preference is given to using the hydrophobin yaad-Xa-dewA-his (SEQ ID NO: 19/SEQ ID NO: 20).

Also proteins which arise starting from the polypeptide sequences shown in SEQ ID NO. 20, 22 or 24 through replacement, insertion or deletion of at least one, up to 10, preferably 5, particularly preferably 5% of all amino acids, and which still have at least 50% of the biological property of the starting proteins are particularly preferred embodiments. Here, biological property of the proteins is understood as meaning the already-described change in contact angle by at least 20°.

Derivatives suitable particularly for carrying out the present invention are derivatives derived from yaad-Xa-dewA-his (SEQ ID NO: 20), yaad-Xa-rodA-his (SEQ ID NO: 22) or yaad-Xa-basf1-his (SEQ ID NO: 24), by shortening the yaad fusion partners. Instead of the complete yaad fusion partner (SEQ ID NO: 16) with 294 amino acids, the shortened yaad radical can advantageously be used. However, the shortened radical should comprise at least 20, preferably at least 35, amino acids. For example, a shortened radical with 20 to 293, preferably 25 to 250, particularly preferably 35 to 150 and for example, 35 to 100 amino acids can be used. A cleavage site between the hydrophobin and the fusion partner or the fusion partners can be utilized to cleave off the fusion partner and to release the pure hydrophobin in underivatized form (for example by BrCN cleavage on methionine, factor Xa cleavage, enterokinase cleavage, thrombin cleavage, TEV cleavage etc.).

Within the context of the invention, preference is given to using the protein yaad40-Xa-dewA-his (SEQ ID NO: 26 herein and in PCT/EP2006/064720), which has a yaad radical shortened to 40 amino acids. The hydrophobins used in the method according to the invention for cleaning hydrophobic surfaces can be prepared chemically by known methods of peptide synthesis, such as, for example, by solid-phase synthesis in accordance with Merrifield. Naturally occurring hydrophobins can be isolated from natural sources by means of suitable methods. By way of example, reference may be made to Wösten et. al., Eur. J. Cell. Bio. 63, 122-129 (1994) or WO 1996/41882. A genetically engineered production method for hydrophobins without fusion partner from Talaromyces thermophilus is described in US 2006/0040349.

The preparation of fusion proteins can preferably take place by genetic engineering methods in which a nucleic acid sequence coding for the fusion partner and a nucleic acid sequence coding for the hydrophobin part, in particular DNA sequence, are combined such that, in a host organism, through gene expression of the combined nucleic acid sequence, the desired protein is produced. One such preparation method is disclosed, for example by WO 2006/082251 or WO 2006/082253. The fusion partners make the preparation of the hydrophobins considerably easier. Fusion hydrophobins are produced in the genetic engineering methods with considerably better yields than hydrophobins without fusion partners.

The fusion hydrophobins produced from the host organisms by the genetic engineering method can be worked up in a manner known in principle and be purified by means of known chromatographic methods. In one preferred embodiment, the simplified work-up and purification method disclosed in WO 2006/082253, pages 11/12, can be used. For this, the fermented cells are firstly separated off from the fermentation broth, disrupted and the cell debris is separated from the inclusion bodies. The latter can advantageously take place by centrifugation. Finally, the inclusion bodies can be disrupted, for example, by acids, bases and/or detergents in a manner known in principle, in order to release the fusion hydrophobins. The inclusion bodies with the fusion hydrophobins used according to the invention can generally be completely dissolved even using 0.1 m NaOH within about 1 h.

The resulting solutions can—optionally after establishing the desired pH—be used without further purification for implementing this invention. The fusion hydrophobins can, however, also be isolated as a solid from the solutions. Preferably, the isolation can take place by means of spray-granulation or spray-drying, as is described in WO 2006/082253, page 12. The products obtained after the simplified work-up and purification method comprise, besides remains of cell debris, generally ca. 80 to 90% by weight of proteins. The amount of fusion hydrophobins is generally 30 to 80% by weight, with regard to the amount of all proteins, depending on fusion construct and fermentation conditions.

The isolated products comprising fusion hydrophobins can be stored as solids and be dissolved for use in the media desired in each case. The fusion hydrophobins can be used as such or else after cleaving off and separating off the fusion partner as “pure” hydrophobins for implementing this invention. A cleavage is advantageously undertaken following isolation of the inclusion bodies and their dissolution.

In one preferred embodiment of the invention, the hydrophobin used is at least one fusion hydrophobin with a polypeptide sequence selected from the group of yaad-Xa-dewA-his (SEQ ID NO: 20), yaad-Xa-rodA-his (SEQ ID NO: 22) or yaad-Xa-basf1-his (SEQ ID NO: 24) and yaad40-Xa-dewA-his (SEQ ID NO: 26 herein and in PCT/EP2006/064720). Particular preference is given to the use of a fusion hydrophobin with a shortened fusion partner such as protein yaad40-Xa-dewA-his (SEQ ID NO: 26 herein and in PCT/EP2006/064720), which has a yaad radical shortened to 40 amino acids.

The present invention relates to a method for cleaning hydrophobic, in particular hard, surfaces, comprising the steps:

a) wetting of the surface with an aqueous composition,
b) absorption of soilings by suitable means,
where the aqueous composition used comprises at least the following components:
(i) at least one solvent (S), where the solvent comprises at least 90% by weight, preferably 95%, particularly preferably 98%, of water,
(ii) at least one hydrophobin (H), preferably selected from yaad-Xa-dewA-his (SEQ ID NO: 20), yaad-Xa-rodA-his (SEQ ID NO: 22), yaad-Xa-basf1-his (SEQ ID NO: 24) or yaad40-Xa-dewA-his (SEQ ID NO: 26),
(iii) at least one non-interface-active, water-soluble additive (A),
(iv) and optionally a surfactant (T),
where the weight ratio of additive (A) to hydrophobin (H) is from 2:1 to 100:1, often also from 5:1 to 100:1.

In one embodiment of the invention, the concentration of the hydrophobin component (H) in the aqueous composition is 0.05 to 50 000 ppm. In a further embodiment of the invention the concentration of the hydrophobin component (H) in the aqueous composition is 1 to 10 000 ppm, often also 100 to 1000 ppm (0.01 to 0.1% by weight), preferably 200 to 800 ppm (0.02 to 0.08% by weight), also preferably from 400 to 600 ppm (0.04 to 0.6% by weight).

In a further embodiment of the invention (diluted application), the concentration of the hydrophobin component (H) in the aqueous composition is 0.05 to 100 ppm, preferably 0.05 to 50 ppm, particularly preferably from 0.05 to 10 ppm.

The sum of the concentrations of all of the components of the aqueous composition—with the exception of the solvent—is often 0.0001 to 10% by weight based on the sum of all of the components of the cleaner formulation.

In one embodiment, the cleaner formulation comprises water as the sole solvent (S). In a further embodiment, it comprises water and 0.001 to 10% by weight of further polar solvents as solvents (S). Preferably, the solvent comprises small amounts of alcohol (e.g. ethanol) and/or ether (e.g. glycol ether). Preferably, the cleaner formulation comprises water and glycol ether. In particular besides water, the solvent (S) comprises alcohol and/or ether in an amount less than 1% by weight, preferably less than or equal to 0.05% by weight (in each case based on the total amount of solvent).

The pH of the aqueous compositions used in the method according to the invention is in particular in the range from 1 to 12, preferably in the range from 2 to 10, particularly preferably in the range from 2 to 8. The pH of the composition is governed in particular by the type of application.

The present invention relates to a method described above, where the non-interface-active, water-soluble additive (A) is in particular a compound which dissociates into ions in aqueous solution and is selected from salts or salt-like compounds or polar organic compounds having a plurality of oxygen-containing functional groups, in particular —COON and/or —OH, preferably having a plurality of —COOH groups.

In particular, the additive (A) present in the cleaner formulation can be selected from the following groups:
water-soluble inorganic salts, such as NaCl, KCl, KBr, CaCl₂, MgCl₂, Na₂CO₃, and NaHCO₃;
water-soluble inorganic salts of organic acids, such as water-soluble salts comprising formates, acetates, oxalates, citrates, gluconates, maleates, succinates, in particular sodium formate, potassium formate, sodium acetate, potassium acetate, sodium oxalates, potassium oxalates;
salts of nitrilotriacetic acid (NTA), ethylenediaminetetraacetic acid (EDTA); diethylenetriaminepentaacetic acid (DTPA), methylglycinediacetic acid (MGDA), hydroxyethylethylenediaminetriacetic acid (HEDTA), in particular sodium or potassium salts;
polar organic compounds having a plurality of oxygen-containing functional groups, in particular —COOH and/or —OH, preferably having a plurality of —COOH groups, in particular formic acid, acetic acid, citric acid, oxalic acid, gluconic acid, maleic acid, succinic acid, nitrilotriacetic acid (NTA), ethylenediaminetetraacetic acid (EDTA); diethylenetriaminepentaacetic acid (DTPA), HEDTA methylglycinediacetic acid (MGDA), hydroxyethylethylenediaminetriacetic acid (HEDTA).

Within the context of the present invention, “water-soluble” is to be understood as meaning compounds which have a solubility in water (at standard temperature 25° C.) of greater than or equal to 10 g/l.

Within the context of the present invention, “non-interface-active” is to be understood as meaning compounds which reduce the surface tension of water (72 N/m, at 25° C.) by not more than 10% when they are dissolved in water up to a concentration of 50 g/l.

Within the context of the present invention, “dissociating into ions in aqueous solution” is understood as meaning compounds which, under solution in water (or in a solvent comprising at least 90% by weight of water), dissociate virtually completely into ions.

Preferably, the additives (A) are used in excess with regard to the hydrophobins; the more dilute the cleaner formulation, the more advantageous a large ratio of additive to hydrophobin may be.

The weight ratio of additive (A) to hydrophobin (H) is preferably 2:1 to 100:1, often also 5:1 to 100:1, preferably 10:1 to 80:1, preferably also 20:1 to 70:1, specifically also 40:1 to 60:1.

The cleaner formulation used in the method according to the invention comprises in particular 5 to 100 000 ppm, preferably 5 to 50 000 ppm, particularly preferably 10 to 30 000 ppm, of at least one non-interface-active, water-soluble additive (A) which dissociates into ions in aqueous solution.

In one preferred embodiment of the invention, the additive (A) is at least one compound selected from the group consisting of: nitrilotriacetic acid (NTA), salts of nitrilotriacetic acid, ethylenediaminetetraacetic acid (EDTA), salts of ethylenediaminetetraacetic acid, diethylenetriaminepentaacetic acid (DTPA), salts of diethylenetriaminepentaacetic acid, methylglycinediacetic acid (MGDA), salts of methylglycinediacetic acid, hydroxyethylethylenediaminetriacetic acid (HEDTA), salts of hydroxyethylethylene-diaminetriacetic acid, tris(hydroxymethyl)aminomethane (Tris), NaCl, KCl, KBr, CaCl₂, MgCl₂, Na₂CO₃, NaHCO₃, 1,2,3-propanetriol (glycerol), gluconic acid, salts of gluconic acid, succinic acid, salts of succinic acid, formic acid, salts of formic acid, in particular sodium formate, potassium formate, acetic acid, salts of acetic acid, in particular sodium acetate, potassium acetate, citric acid, salts of citric acid, in particular sodium citrate and potassium citrate.

In one preferred embodiment, the additive (A) is at least one compound selected from the group consisting of citric acid, salts of citric acid, gluconic acid, salts of gluconic acid, succinic acid and salts of succinic acid. In particular, the additive (A) is citric acid or a salt of citric acid, preferably a compound selected from sodium citrate, potassium citrate and/or citric acid.

Preferably, the additive (A) is low molecular weight compounds with a molecular weight Mₙ of less than 500 g/mol, particularly preferably less than 350 g/mol

The aqueous compositions used in the method described above may optionally comprise further additives. Further additives (Z) which may be present are in particular one or more substances selected from
perfuming agents
dyes
acids
alkalis
preservatives
optionally anionic or amphoteric surfactants.

In one preferred embodiment of the invention, the aqueous composition used in the method according to the invention comprises no further surfactants with the exception of the hydrophobin.

In one preferred embodiment of the invention, the aqueous composition used in the method according to the invention can optionally comprise a small amount of a further surfactant. The hydrophobin present in the cleaner formulation is not referred to as surfactant for the purposes of the invention.

In a further embodiment of the invention, the aqueous composition additionally comprises at least one surfactant (T), preferably in an amount of from 0.01 to 10 000 ppm (10E-6 to 1% by weight), preferably in an amount of 0.01 to 5000 ppm.

In one embodiment the aqueous composition relates to a cleaner concentrate and comprises a surfactant (T) (besides the hydrophobin) in an amount in the range from 0.01 to 1% by weight in particular from 0.05 to 0.5% by weight.

In one embodiment the aqueous composition relates to a dilute cleaner and comprises a surfactant (T) (besides the hydrophobin) in an amount in the range from 0.01 to 1000 ppm, preferably 0.01 to 100 ppm, particularly preferably 0.01 ppm to 50 ppm.

Anionic or amphoteric surfactants can be used as surfactant (T) (besides the hydrophobin); in particular, at least one surfactant selected from sugar surfactants, betaines and fatty alcohol ether sulfates, in particular from alkyl polyglycosides, pentosides and alkylamidopropylbetaine is used.

In one preferred embodiment of the invention, the cleaner formulation used in the method according to the invention comprises a surfactant (T) (besides the hydrophobin) in an amount of not more than 0.5% by weight.

One embodiment of the invention relates to a method for cleaning hydrophobic surfaces comprising the steps:
a) wetting of the surface with an aqueous composition,
b) absorbing the soilings by suitable means, where the aqueous composition used comprises at least the following components (or consists thereof):
(i) 90 to 99.96% by weight of at least one solvent (S), where the solvent often comprises at least 90% by weight, preferably at least 95%, particularly preferably at least 98%, of water,
(ii) 0.05 to 50 000 ppm of at least one hydrophobin (H),
(iii) 5 to 100 000 ppm % of at least one non-interface-active, water-soluble additive
(A) which dissociates into ions in aqueous solution, and
(iv) optionally, 0.01 to 10 000 ppm of a surfactant (T), where the weight ratio of additive (A) to hydrophobin (H) is in the range from 2:1 to 100:1.

Usually, cleaner concentrates are marketed to professional cleaners (e.g. cleaning companies) but also for use as household cleaners; these are later diluted to the desired concentration. In the case of professional cleaning, a distinction is usually made between an occasional intensive cleaning (also first care treatment) and subsequent cleaning with dilute cleaner (so-called maintenance cleaning).

In the method according to the invention, the aqueous composition used can preferably be a mixture of a cleaner concentrate comprising (or consisting of)
(i) 90 to 99.96% by weight of at least one solvent (S), where the solvent comprises at least 90% by weight, preferably at least 95%, particularly preferably at least 98%, of water,
(ii) 0.05 to 50 000 ppm of at least one hydrophobin (H),
(iii) 5 to 100 000 ppm of at least one non-interface-active, water-soluble additive (A) which dissociates into ions in aqueous solution, and
(iv) optionally 0.01 to 10 000 ppm of a surfactant (T),
   and water, where the cleaner concentrate is used in a concentration of from 0.01 to 60% by weight (based on the total aqueous composition).

In one embodiment, the above-described method according to the invention relates to an intensive cleaning (or first care treatment), where the above-described cleaner concentrate is used in a concentration of from 20 to 60% by weight, preferably 20 to 40% by weight, particularly preferably from 20 to 25%. In this embodiment, it is an intensive cleaning. The concentration of the hydrophobin component (H) in the aqueous composition is frequently from 20 to 1000 ppm, often 50 to 300 ppm, preferably also 50 to 200 ppm, particularly preferably 80 to 125 ppm.

One embodiment of the invention relates to a method for cleaning hydrophobic surfaces comprising the steps:
a) wetting the surface with an aqueous composition,
b) absorbing the soilings by suitable means, where the aqueous composition used comprises at least the following components:
(i) 90 to 99.96% by weight of at least one solvent (S), where the solvent comprises at least 90% by weight, preferably at least 95% by weight, particularly preferably at least 98% by weight, of water,
(ii) 20 to 1000 ppm of at least one hydrophobin (H),
(iii) 40 to 100 000 ppm, often 50 to 30 000 ppm, preferably 100 to 20 000 ppm of at least one non-interface-active, water-soluble additive (A),
(iv) optionally, 0.01 to 10 000 ppm, preferably 0.2 to 4000 ppm of at least one surfactant (T),
   where the weight ratio of additive (A) to hydrophobin (H) is in the range from 2:1 to 100:1.

After the so-called first care treatment or after an intensive cleaning, cleaning is preferably only then carried out with a dilute maintenance cleaner, the above-described cleaner concentrate being present in the aqueous composition in a concentration of from 0.01 to 20% by weight, preferably 0.01 to 10% by weight, particularly preferably from 0.01 to 2%.

In one embodiment, the invention relates to a method which is a maintenance cleaning and in which the concentrations of the hydrophobin component (H) in the aqueous composition are from 0.05 to 50 000 ppm, preferably from 0.05 to 5000 ppm. If necessary, an interim cleaning can take place even just with water.

The described intensive cleaning or first care treatment and the diluted application (maintenance cleaning) can take place in the long term or alternately. A concentrated application can take place as first care treatment with a subsequent maintenance cleaning.

The amount of hydrophobins also depends on the nature of the surface; in the case of strongly water-repelling surfaces (e.g. floors coated with PUR, PVC floorings), a higher hydrophobin concentration is required in the wiping water than in the case of a more hydrophilic surface.

Preferably, the hydrophobic surface to be cleaned should be wetted once completely with the aqueous composition. It is also advantageous not to clean the surface in between times with (conventional) surfactant cleaners. In particular, the invention relates to a method for cleaning hard and elastic surfaces.

The terms “hard surfaces” and “elastic surfaces” are known to a person skilled in the art. “Hard surfaces” are surfaces that are only compressible to a small extent, if at all, in particular smooth surfaces, for example surfaces made of glass, ceramic, metals, such as, for example, stainless steel or brass, enamel, plastic and/or painted surfaces. Examples of painted surfaces comprise the surface of painted automobile bodies or the surface of domestic appliances. The hard surfaces may be in particular typical surfaces in the home, such as, for example, the surface of tiles, floors, in particular plastic floors, fittings, washbasins, shower trays, bathtubs, toilets, shower cubicles, bathroom furniture, kitchen furniture, such as tables, chairs, cupboards, work surfaces or other furniture, mirrors, windows, crockery, cutlery, glassware, porcelain objects or the surfaces of domestic appliances such as washing machines, dishwashers, ovens or extractor hoods. Soilings (or soil) are, in a known manner, all types of undesired material on surfaces in the form of solid and/or liquid substances. Examples of soil comprise fats, oils, proteins, food residues, dust or earth. Soilings may also be lime deposits, such as for example dried-on traces of water which are formed on account of water hardness. Further examples comprise residues of cleaners and care compositions.

In particular, the method according to the invention relates to the cleaning of a hydrophobic, in particular hard, poorly wettable surface. The surface is in particular a plastic surface, as is typically used for floors or domestic objects. Preferably, the method according to the invention relates to the cleaning of a hard, hydrophobic surface selected from polyethylene PE, polypropylene PP, polyvinyl chloride PVC, polyethylene terephthalate PET, polyurethane PUR, linoleum and rubber.

Preferably, the invention relates to a method described above, wherein the hydrophobic surfaces are plastic floors. In particular, the hydrophobic surfaces are floors made of a material selected from the group consisting of polyethylene PE, polypropylene PP, polyvinyl chloride PVC, polyethylene terephthalate PET, polyurethane PUR, linoleum and rubber and mixtures and combinations thereof.

Within the context of the present invention, a hydrophobic surface is to be understood as meaning a surface for which the contact angle of a water drop on the surface is greater than 50°, preferably greater than 60°, the values referring to an untreated surface.

The present invention further relates to a composition for cleaning hydrophobic surfaces, in particular a cleaner concentrate, comprising:
90 to 99.96% by weight of at least one solvent (S), where the solvent comprises at least 90% by weight, preferably at least 95% by weight, particularly preferably at least 98% by weight, of water,
0.001 to 0.5% by weight of at least one hydrophobin (H), preferably selected from yaad-Xa-dewA-his (SEQ ID NO: 20), yaad-Xa-rodA-his (SEQ ID NO: 22), yaad-Xa-basf1-his (SEQ ID NO: 24) or yaad40-Xa-dewA-his (SEQ ID NO: 26),
1 to 10% by weight, often 1 to 5% by weight (preferably 1-3% by weight), of at least one non-interface-active, water-soluble additive (A),
optionally 0.1 to 1% by weight of a surfactant (T),
   where the weight ratio of additive (A) to hydrophobin (H) is from 2:1 to 100:1, and where the additive (A) is selected from the group consisting of citric acid, gluconic acid, succinic acid, and salts thereof in each case.

In particular, the components described above in connection with the method according to the invention (solvent (S), hydrophobin (H), additive (A), surfactant (T), further additives (Z)) may be present in the compositions according to the invention for cleaning.

Preferably, the composition for cleaning hydrophobic surfaces comprises (or consists of):
90 to 99.96% by weight of at least one solvent (S), where the solvent comprises at least 90% by weight, preferably at least 95% by weight, particularly preferably at least 98% by weight, of water,
0.04 to 0.06% by weight of at least one hydrophobin (H), preferably selected from yaad-Xa-dewA-his (SEQ ID NO: 20), yaad-Xa-rodA-his (SEQ ID NO: 22), yaad-Xa-basf1-his (SEQ ID NO: 24) or yaad40-Xa-dewA-his (SEQ ID NO: 26),
1 to 10% by weight, often 1 to 3% by weight, of at least one non-interface-active, water-soluble additive (A),
optionally 0.1 to 0.6% by weight surfactant (T),
   where the weight ratio of additive (A) to hydrophobin (H) is from 5:1 to 100:1, and where the additive (A) is selected from the group consisting of citric acid, gluconic acid, succinic acid and salts thereof in each case, preferably their alkali metal and alkaline earth metal salts.

The invention also relates to a method for cleaning hydrophobic surfaces comprising the steps:
a) wetting the surface with an aqueous composition,
b) absorbing the soilings by suitable means,
where the aqueous composition used comprises at least the following components:
(i) at least one solvent (S), where the solvent comprises at least 90% by weight of water,
(ii) at least one hydrophobin (H),
(iii) at least one non-interface-active, water-soluble additive (A),
(iv) and optionally a surfactant (T),
where the weight ratio of additive (A) to hydrophobin is from 2:1 to 100:1.

Preference is also given to a composition for cleaning hydrophobic surfaces comprising (or consisting of):
90 to 99.96% by weight of solvent (S),
where the solvent comprises at least 90% by weight,
1 to 10 000 ppm of at least one hydrophobin (H),
5 to 100 000 ppm of at least one non-interface-active water-soluble additive (A),
and optionally
0.01 to 10 000 ppm of a surfactant (T),
where the weight ratio of additive (A) to hydrophobin (H) is from 5:1 to 100:1, and
where the additive (A) is citric acid or a salt of citric acid.

In particular, the composition according to the invention for cleaning hydrophobic surfaces consists of the aforementioned components.

In one embodiment, the present invention relates to a composition described above wherein the additive (A) is selected from citric acid, gluconic acid and succinic acid.

In one embodiment, the present invention relates to a composition described above wherein the additive (A) is selected from citric acid, sodium citrate and potassium citrate, particularly preferably citric acid or sodium citrate.

In one embodiment, the composition for cleaning according to the invention comprises a surfactant (T) (besides the hydrophobin) in an amount in the range from 0.01 to 0.5% by weight, in particular from 0.05 to 0.5% by weight, preferably 0.1 to 0.5% by weight. For the purposes of the invention, the hydrophobin present in the composition for cleaning is not referred to as surfactant. In particular, the cleaner formulation comprises a surfactant (T) (besides the hydrophobin) in an amount of not more than 0.5% by weight. In particular anionic or amphoteric surfactants can be used as surfactant (T) (besides the hydrophobin); in particular at least one surfactant is selected from sugar surfactants, betaines and fatty alcohol ether sulfates, in particular from alkyl polyglycosides, pentosides and alkylamidopropylbetaines.

Furthermore, the present invention relates to a method for producing the above-described composition for cleaning hydrophobic surfaces, where the specified components are mixed. Preferably, a solution of the hydrophobin (H) in part of the solvent (S) is mixed with a solution of the additive (A) in another part of the solvent (S).

Furthermore, the present invention relates to the use of an aqueous composition comprising at least one hydrophobin (H) and at least one non-interface-active, water-soluble additive (A) (dissociating into ions in particular in aqueous solution) for cleaning hydrophobic hard surfaces. In particular, it concerns the use for cleaning plastic floors, preferably plastic floors selected from polyethylene PE, polypropylene PP, polyvinyl chloride PVC, polyethylene terephthalate PET, polyurethane PUR, linoleum and rubber.

Preferably, the use of the composition according to the invention takes place as industrial cleaners, domestic cleaners, auto care and/or cleaning compositions, glass cleaners, floor cleaners, all-purpose cleaners, bath cleaners, rinse aids, dishwashing compositions for manual or machine dishwashing, machine cleaners, metal degreasers, high-pressure cleaners, alkaline cleaners, acidic cleaners or dairy cleaners.

The present invention is illustrated in more detail by the following examples.

### Example 1

### Preparation of the Hydrophobins

For the examples, a fusion hydrophobin with a fusion partner yaad40-Xa-dewA-his shortened to 40 amino acids (referred to below also as hydrophobin protein B or H*-protein B) was used.

The preparation of the hydrophobins was carried out according to the procedure described in WO 2006/082253. The products were worked up by the simplified purification method according to example 9 of WO 2006/82253 and spray-dried according to example 10. The total protein content of the resulting, dried products was in each case ca. 70 to 95% by weight, the content of hydrophobins was ca. 40 to 90% by weight with regard to the total protein content. The products were used as such for the experiments.

TABLE 1
Formulations example 1

| | Formulation | Formulation | Formulation |
|---|---|---|---|
| | A | B | C |
| Raw materials | [%] | [%] | [%] |
| Water | 98.00 | 99.95 | 97.95 |
| Hydrophobin-protein B | — | 0.05 | 0.05 |
| Iminodisuccinate Na salt | 2.00 | — | 2.00 |

### Example 2

### Wetting Effect of the Combination

Contact angle measurements were carried out.

The following formulations were prepared by mixing the components: 5 ml of the solutions prepared as described above were applied to a 15×15 cm section of dance floor (PVC floor covering) and dried for 24 h at room temperature.

The contact angle of water was measured on these test coverings, the average being taken from 5 measurements.

A contact angle measuring instrument of the type DSA 10 MK2 (Krüss GmbH) was used. To measure the contact angle, a 5 μl water drop was used. The measurements were carried out at a temperature of 20° C. The results are summarized in table 2.

TABLE 2
Results of the contact angle measurement

| | Floor | | | |
|---|---|---|---|---|
| | covering | Formulation | Formulation | Formulation |
| | untreated | A | B | C |
| 1st | 92.7 | 80.8 | 48.5 | 14.4 |
| measurement | | | | |
| 2nd | 91.4 | 79.5 | 35.5 | 16.2 |
| measurement | | | | |
| 3rd | 90.3 | 80.4 | 48.9 | 15.3 |
| measurement | | | | |
| 4th | 88.1 | 82.3 | 44.9 | 17.3 |
| measurement | | | | |
| 5th | 87.5 | 82.9 | 41.1 | 13.8 |
| measurement | | | | |
| Average | 90.0 | 81.2 | 43.8 | 15.4 |

### Example 3

A stock solution of 5000 ppm of H*protein B (EV 153178) (0.5% by weight) was prepared in demineralized water. Corresponding amounts of this were placed in additive solutions prepared beforehand to give a protein concentration of 500 ppm (0.05% by weight).

Additive solutions according to table 3 were prepared. The results relating to the wetting behavior are likewise given in table 3.

Nonpolar plastic surfaces as given in table 3 were immersed into the solutions and removed from the particular solution after 5 seconds.

The wetting power of the solutions on the surfaces was visually assessed as follows:
+ incomplete wetting
++ almost complete wetting, edge areas problematic
+++ uniform wetting

TABLE 3
Assessment of the wetting behavior

| | | | | | Wetting |
|---|---|---|---|---|---|
| | | | | | effect on |
| | | Conc. | | | plastic |
| No. | Additive | in % | mmol/l | pH | surfaces |
| 1 | Without | — | — | 8.8 | + |
| 2 | Nitrilotriacetic acid (NTA, | 0.5 | 19.5 | 11.6 | +++ |
| | Trilon A) | | | | |
| 3 | Ethylenediaminetetraacetic | 0.5 | 13.2 | 11.5 | +++ |
| | acid (EDTA, Trilon B) | | | | |
| 4 | Ethylenediaminetetraacetic | 0.5 | 14.6 | 8.0 | +++ |
| | acid neutralized with | | | | |
| | triammonium (Trilon BAT) | | | | |
| 5 | Diethylenetriaminepentaacetic | 0.5 | 9.9 | 11.5 | +++ |
| | acid (DTPA, Trilon C) | | | | |
| 6 | Hydroxyethylethylene- | 0.5 | 14.5 | 11.6 | ++ |
| | diaminetriacetic acid | | | | |
| | (HEDTA, Trilon D) | | | | |
| 7 | Methylglycinediacetic acid | 0.5 | 18.5 | 11.5 | +++ |
| | (MGDA, Trilon M) | | | | |
| 8 | Tris(hydroxymethyl)amino- | 0.606 | 50.0 | 8.0 | +++ |
| | methane (TRIS) | | | | |
| 9 | Sodium chloride (NaCl) | 0.580 | 100.0 | 8.1 | +++ |
| 10 | Calcium chloride (CaCl₂) | 0.735 | 50.0 | 7.2 | +++ |
| 12 | Gluconic acid | 1.091 | 50.0 | 7.1 | +++ |
| 13 | Succinic acid | 0.810 | 50.0 | 8.7 | +++ |

### Example 4

A hydrophobin-protein B stock solution in water of 5000 ppm (based on solids content) was prepared.

Aqueous solutions of the following additives (A) tris(hydroxymethyl)aminomethane Tris), NaCl, sodium formate, potassium formate, trisodium citrate and CaCl₂ were prepared as in table 4.

TABLE 4
Additive solutions for example 4

| | | | % by | |
|---|---|---|---|---|
| No. | Additive | Concentration | weight | pH |
| 1 | — | | | 8.8 |
| 2 | NaCl | 100 mmol | 0.58% | 8.1 |
| 3 | Na₃ citrate | 25 mmol | 0.65% | 9.0 |
| 4 | CaCl₂ | 50 mmol | 0.74% | 7.2 |

Each 40 ml of the aforementioned solutions were admixed with a corresponding amount (0.04 ml, 0.08 ml, 0.2 ml, 0.4 ml, 0.8 ml, 4.0 ml) of hydrophobin stock solution, to give overall concentrations of hydrophobin B of 5, 10, 25, 50, 100 and 500 ppm.

The solutions obtained in this way were applied to sheets made of the following plastics: polycarbonate, polymethyl methacrylate PMMA, polyvinyl chloride, polyethylene terephthalate PET, polypropylene PP, polyethylene PE. The wetting behavior was visually assessed as follows:
0 no wetting
+ slight wetting effect on the substrate, although the placed drops can be combined as streaks
++ virtually complete wetting of the substrate, only slight retreat tendencies at the edges, multiple mechanical spreading necessary
+++ wetting over the area which can be achieved by simple spreading.

Table 5 summarizes the results for the different plastic surfaces.

TABLE 5
Assessment of the wetting behavior at
different hydrophobin concentrations

| | |
|---|---|
| Protein | Methods |

| | | | | |
|---|---|---|---|---|
| concentration | 1 | 2 | 3 | 4 |

Polycarbonate

| | | | | |
|---|---|---|---|---|
| Without | 0 | 0 | 0 | 0 |
| 5 ppm | 0 | 0 | + | 0 |
| 10 ppm | 0 | + | + | 0 |
| 25 ppm | 0 | + | ++ | + |
| 50 ppm | 0 | ++ | +++ | ++ |
| 100 ppm | 0 | +++ | +++ | +++ |
| 500 ppm | + | +++ | +++ | +++ |

PMMA

| | | | | |
|---|---|---|---|---|
| Without | 0 | 0 | 0 | 0 |
| 5 ppm | 0 | + | + | 0 |
| 10 ppm | 0 | + | + | 0 |
| 25 ppm | 0 | + | ++ | + |
| 50 ppm | 0 | ++ | +++ | ++ |
| 100 ppm | 0 | +++ | +++ | +++ |
| 500 ppm | + | +++ | +++ | +++ |

PVC

| | | | | |
|---|---|---|---|---|
| Without | 0 | 0 | 0 | 0 |
| 5 ppm | 0 | + | + | + |
| 10 ppm | 0 | + | ++ | + |
| 25 ppm | + | ++ | +++ | ++ |
| 50 ppm | + | +++ | +++ | ++ |
| 100 ppm | + | +++ | +++ | +++ |
| 500 ppm | + | +++ | +++ | +++ |

PET

| | | | | |
|---|---|---|---|---|
| Without | 0 | 0 | 0 | 0 |
| 5 ppm | 0 | + | + | + |
| 10 ppm | + | + | ++ | + |
| 25 ppm | + | + | ++ | + |
| 50 ppm | + | ++ | +++ | ++ |
| 100 ppm | + | +++ | +++ | +++ |
| 500 ppm | ++ | +++ | +++ | +++ |

PP

| | | | | |
|---|---|---|---|---|
| Without | 0 | 0 | 0 | 0 |
| 5 ppm | 0 | 0 | + | 0 |
| 10 ppm | 0 | + | + | + |
| 25 ppm | 0 | + | ++ | + |
| 50 ppm | 0 | ++ | ++ | ++ |
| 100 ppm | 0 | +++ | +++ | +++ |
| 500 ppm | + | +++ | +++ | +++ |

PE

| | | | | |
|---|---|---|---|---|
| Without | 0 | 0 | 0 | 0 |
| 5 ppm | 0 | 0 | + | 0 |
| 10 ppm | 0 | + | + | + |
| 25 ppm | 0 | + | ++ | + |
| 50 ppm | 0 | ++ | +++ | ++ |
| 100 ppm | 0 | +++ | +++ | +++ |
| 500 ppm | + | +++ | +++ | +++ |

Assignment of the sequence names to DNA and polypeptide sequences in the sequence listing

| | |
|---|---|
| dewA DNA and polypeptide sequence | SEQ ID NO: 1 |
| dewA polypeptide sequence | SEQ ID NO: 2 |
| rodA DNA and polypeptide sequence | SEQ ID NO: 3 |
| rodA polypeptide sequence | SEQ ID NO: 4 |
| hypA DNA and polypeptide sequence | SEQ ID NO: 5 |
| hypA polypeptide sequence | SEQ ID NO: 6 |
| hypB DNA and polypeptide sequence | SEQ ID NO: 7 |
| hypB polypeptide sequence | SEQ ID NO: 8 |
| sc3 DNA and polypeptide sequence | SEQ ID NO: 9 |
| sc3 polypeptide sequence | SEQ ID NO: 10 |
| basf1 DNA and polypeptide sequence | SEQ ID NO: 11 |
| basf1 polypeptide sequence | SEQ ID NO: 12 |
| basf2 DNA and polypeptide sequence | SEQ ID NO: 13 |
| basf2 polypeptide sequence | SEQ ID NO: 14 |
| yaad DNA and polypeptide sequence | SEQ ID NO: 15 |
| yaad polypeptide sequence | SEQ ID NO: 16 |
| yaae DNA and polypeptide sequence | SEQ ID NO: 17 |
| yaae polypeptide sequence | SEQ ID NO: 18 |
| yaad-Xa-dewA-his DNA and polypeptide sequence | SEQ ID NO: 19 |
| yaad-Xa-dewA-his polypeptide sequence | SEQ ID NO: 20 |
| yaad-Xa-rodA-his DNA and polypeptide sequence | SEQ ID NO: 21 |
| yaad-Xa-rodA-his polypeptide sequence | SEQ ID NO: 22 |
| yaad-Xa-basf1-his DNA and polypeptide sequence | SEQ ID NO: 23 |
| yaad-Xa-basf1-his polypeptide sequence | SEQ ID NO: 24 |
| yaad40-Xa-dewA-his DNA and polypeptide sequence | SEQ ID NO: 25 |
| yaad40-Xa-dewA-his polypeptide sequence | SEQ ID NO: 26 |

1. A method for cleaning hydrophobic surfaces comprising the steps of:
a) wetting of the surface with an aqueous composition,
b) absorbing the soilings by suitable means,
where the aqueous composition comprises at least the following components:
(i) a solvent (S) comprising at least 90% by weight of water,
(ii) a hydrophobin (H),
(iii) a non-interface-active, water-soluble additive (A),
(iv) and, optionally, a surfactant (T),
wherein the weight ratio of additive (A) to hydrophobin (H) is from 2:1 to 100:1.

2. The method of claim 1, wherein the concentration of the hydrophobin (H) in the aqueous composition is 0.05 to 50,000 ppm.

3. The method of claim 1, wherein the aqueous composition comprises the surfactant (T) in an amount of from 0.01 to 10,000 ppm.

4. The method of claim 1, wherein the additive (A) is a compound selected from the group consisting of nitrilotriacetic acid (NTA), salts of nitrilotriacetic acid, ethylenediaminetetraacetic acid (EDTA), salts of ethylenediaminetetraacetic acid, diethylenetriaminepentaacetic acid (DTPA), salts of diethylenetriaminepentaacetic acid, methylglycinediacetic acid (MGDA), salts of methylglycinediacetic acid, hydroxyethylethylenediaminetriacetic acid (HEDTA), salts of hydroxyethylethylenediaminetriacetic acid, tris (hydroxymethyl)aminomethane (Tris), NaCl, KCl, KBr, CaCl₂, MgCl₂, Na₂CO₃, NaHCO₃, 1,2,3-propanetriol (glycerol), gluconic acid, salts of gluconic acid, succinic acid, salts of succinic acid, formic acid, salts of formic acid, acetic acid, salts of acetic acid, citric acid and salts of citric acid.

5. The method of claim 1, wherein the additive (A) is a compound selected from the group consisting of citric acid, salts of citric acid, gluconic acid, salts of gluconic acid, succinic acid and salts of succinic acid.

6. The method of claim 1, wherein the additive (A) is citric acid or a salt of citric acid.

7. The method of claim 1, wherein the hydrophobic surfaces are floors made of plastic.

8. The method of claim 1, wherein the hydrophobic surfaces are floors made of a material selected from the group consisting of polyethylene PE, polypropylene PP, polyvinyl chloride PVC, polyethylene terephthalate PET, polyurethane PUR, linoleum and rubber.

9. The method of claim 1, wherein the cleaning is an intensive cleaning, and the concentration of the hydrophobic component (H) in the aqueous composition is from 20 to 2000 ppm.

10. The method of claim 1, wherein the cleaning is a maintenance cleaning, and the concentration of the hydrophobin component (H) in the aqueous composition is from 0.05 to 100 ppm.

11. A composition for cleaning hydrophobic surfaces comprising the following components:
90 to 99.96% by weight of a solvent (S), wherein the solvent comprises at least 90% by weight of water,
0.05 to 50,000 ppm of a hydrophobin (H),
5 to 100,000 ppm of a non-interface-active water-soluble additive (A),
and, optionally, 0.01 to 10,000 ppm of a surfactant (T),
where the weight ratio of the additive (A) to the hydrophobin (H) is from 2:1 to 100:1, and wherein the additive (A) is selected from the group consisting of: citric acid, gluconic acid, succinic acid, and salts thereof.

12. The composition of claim 11 comprising the following components:
90 to 99.96% by weight of the solvent (S), wherein the solvent comprises at least 90% by weight of water,
1 to 10,000 ppm of the hydrophobin (H),
5 to 100,000 ppm of the non-interface-active water-soluble additive (A),
and, optionally, 0.01 to 10,000 ppm of the surfactant (T),
where the weight ratio of the additive (A) to the hydrophobin (H) is from 5:1 to 100:1, and wherein the additive (A) is citric acid or a salt of citric acid.

13. A method for cleaning a hydrophobic surface comprising contacting the surface with an aqueous composition comprising a hydrophobin (H) and a non-interface-active, water-soluble additive (A).

14. The method of claim 13, wherein the hydrophobin (H) concentration is 0.05 to 50,000 ppm.

15. The method of claim 13, wherein the hydrophobic surface is a plastic floor.
